(19) United States
(12) Patent Application Publication
(10) Pub. No.: US 2011/0311862 A1
(43) Pub. Date: Dec. 22, 2011

(54) SECONDARY BATTERY

(75) Inventor: Chang-Bum Ahn, Yongin-si (KR)

(73) Assignee: Samsung SDI Co., Ltd., Yongin-si (KR)

(21) Appl. No.: 13/085,412

(22) Filed: Apr. 12, 2011

Related U.S. Application Data
(60) Provisional application No. 61/357,024, filed on Jun. 21, 2010.

(51) Int. Cl. H01M 2/02; H01M 2/30; H01M 2/08

(52) U.S. Cl. 429/179; 429/185

(57) ABSTRACT

The embodiment relates to a pouch-typed secondary battery, which includes: an electrode assembly having electrode taps connected to two electrode having different polarities; a case accommodating the electrode assembly with the electrode taps led to the outside; and bonding members sealing the case, in which the bonding members are disposed where the case is bonded. Further, the bonding members of the pouch-typed secondary battery according to the present invention may be composed of one or more layers.

### FIELD OF THE INVENTION

The embodiment relates to a secondary battery including an electrode assembly and a pouch-typed case.

### Technical Field and Background Art

In general, an insulating tape is attached to an electrode tap of an electrode assembly to prevent a short-circuit with a pouch-typed case.

In this secondary battery, the insulating tape attached to the electrode tap may cause leakage of electrolyte by preventing the sealing of the case.

### DISCLOSURE

### Technical Problem

The embodiment is to provide a secondary battery that prevents a short-circuit between an electrode tap and a pouch-type case without using an insulating tape for the electrode tap.

Further, the embodiment is to provide a secondary battery that can prevent leakage of electrolyte.

Further, the embodiment is to manufacture a secondary battery having large capacity by variously changing the thickness of an electrode assembly disposed in a pouch-type case.

### Technical Solution

The embodiment is to provide a secondary battery described as follows.

According to an aspect of the present invention, a pouch-typed secondary battery includes: an electrode assembly having electrode taps connected to two electrode having different polarities; a case accommodating the electrode assembly with the electrode taps led to the outside; and bonding members sealing the case, in which the bonding members are disposed where the case is bonded.

The case is a rectangular laminate sheet including an inner resin layer, a metal layer, and an outer resin layer. Further, the inner resin layer may further include an adhesive layer.

The bonding members may be disposed only where the case is bonded.

The bonding member may be made of any one or more of polypropylene, polyethylene, polyethylene terephthalate, and polyacrylonitrile.

It is preferable that the thickness of the bonding members is 100 μm to 200 μm.

According to another aspect of the present invention, a pouch-typed secondary battery includes: an electrode assembly having electrode taps connected to two electrode having different polarities; and a case accommodating the electrode assembly with the electrode taps led to the outside, in which bonding members composed of one or more layers are disposed where the case is bonded.

The bonding members may be composed of one or more layers. In this configuration, the bonding members include first, second, and third bonding members. The first bonding member is a portion contacting the electrode tap and preferably made of any one or more of polypropylene, polyethylene, polyethylene terephthalate, and polyacrylonitrile.

The thickness of the first bonding member may be 100 μm to 200 μm.

The second bonding member is disposed between the first and third bonding members, and for example, may be made of CPP (cast polypropylene; CPP).

The third bonding member is disposed between the second bonding member and the case and for example, made of any one or more of polypropylene, polyethylene, polyethylene terephthalate, and polyacrylonitrile.

According to another aspect of the present invention, a pouch-typed secondary battery includes: an electrode assembly having electrode taps connected to two electrode having different polarities; and a case accommodating the electrode assembly with the electrode taps led to the outside, in which bonding members including first and second bonding members and a spacer disposed between the bonding members are disposed where the case is bonded.

The first bonding member is a portion contacting the electrode tap and preferably made of any one or more of polypropylene, polyethylene, polyethylene terephthalate, and polyacrylonitrile.

The thickness of the first bonding member may be 100 μm to 200 μm.

The spacer may be made of metal or engineering plastic. Preferably, the metal includes aluminum, stainless steel, and nickel. Further, the engineering plastic includes polycarbonate, nylon, polyamide, polybutylene terephthalate, and polyethylene terephthalate.

The spacer may further have two steps. It is preferable that the steps are spaced from each other.

The second bonding member is disposed between the spacer and the case and for example, made of any one or more of CPP, polypropylene, polyethylene, polyethylene terephthalate, and polyacrylonitrile.

### Effects of the Invention

An insulating tape is not attached to the electrode taps of the electrode assembly of the secondary battery according to the present invention. Therefore, it is possible to reduce the manufacturing cost, because an insulating tap and a process of attaching the insulating tape are not needed in the secondary battery.

Further, the secondary battery according to the present invention is a pouch-typed secondary battery, in which there is no insulating tape where the case of the secondary battery is bonded. Therefore, it is possible to degree of bonding of the case of the secondary battery, thereby preventing leakage of electrolyte.

Further, in the case of the secondary battery according to the present invention, the housing portion for the electrode assembly in the case may be formed by the bonding members including the spacers. Therefore, it is possible to reduce the cost for the process, because deep drawing for forming the housing portion in the case is not needed. Further, the size of the housing portion of the electrode assembly is not limited by deep drawing. Accordingly, it is possible to variously change the thickness of the electrode assembly, and particularly, it is advantageous of manufacturing a secondary battery having high capacity.

### BRIEF DESCRIPTION OF DRAWINGS

FIG. 1 is a perspective view of a pouch-typed secondary battery according to an embodiment of the present invention,

FIG. 2 is an exploded view of the secondary battery shown in FIG. 1,

FIG. 3 is a view enlarging the portion A of FIG. 2,

FIG. 4 is a perspective view of a pouch-typed secondary battery according to an embodiment of the present invention,

FIG. 5 is an exploded view of the secondary battery shown in FIG. 4,

FIG. 6 is a view enlarging the portion B of FIG. 5,

FIG. 7 is a perspective view of a pouch-typed secondary battery according to an embodiment of the present invention,

FIG. 8 is an exploded view of the secondary battery shown in FIG. 7,

FIG. 9 is a view enlarging the portion C of FIG. 8,

FIG. 10 is a perspective view of a pouch-typed secondary battery according to an embodiment of the present invention,

FIG. 11 is an exploded view of the secondary battery shown in FIG. 10,

FIG. 12 is a view enlarging the portion D of FIG. 11,

FIG. 13 is a perspective view showing the front of a pouch-typed secondary battery according to an embodiment of the present invention.

### DETAILED DESCRIPTION OF EXEMPLARY EMBODIMENTS

Embodiments of the present invention and other information for those skilled in the art to easily understand the present invention are described hereafter in detail with the accompanying drawings. However, the present invention may be changed and modified in various ways within the scope described in claims; therefore, it can be understood by those skilled in the art that the embodiment described below are just exemplified.

When it is determined that detailed descriptions for well-known technologies may unnecessarily make the point of the present invention unclear, the detailed descriptions are not provided, in explaining the present invention. Further, eve if the same components are shown in different figures of the drawings, it should be noted that they are represented by as the same reference numerals or characters as possible. In addition, the size or thickness may be exaggerated or reduced in the drawings for the convenience of description and clarity, and may be different from the thickness or size of the actual layers.

The configuration and operation of embodiments according to the present invention are described hereafter in detail with reference to the accompanying drawings.

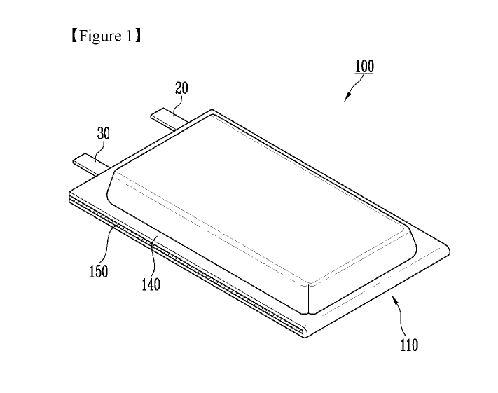

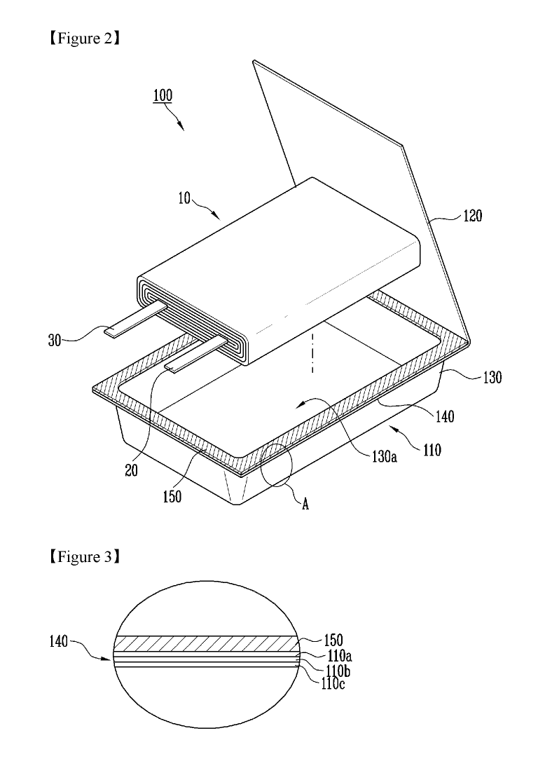

FIG. 1 is a perspective view of a pouch-type secondary battery according to an embodiment of the present invention, FIG. 2 is an exploded view of the secondary battery shown in FIG.1, and FIG. 3 is a view enlarging the portion A of FIG. 2.

A pouch-typed secondary battery according to an embodiment of the present invention is described hereafter with reference to FIGS. 1 to 3.

Referring to FIGS. 1 and 2, a pouch-type secondary battery 100 according to the present embodiment includes an electrode assembly 10, a pouch-typed case 110 accommodating the electrode assembly 10, and a bonding member 150 for sealing the pouch-typed case 110. The case 110 has a bonding portion 140 where the bonding member 150 for sealing the case 110 is disposed.

First, in the electrode assembly 10, the electrode assembly 10 is formed by winding a first electrode plate, a second electrode plate, and a separator interposed between the electrode plates. A first electrode tap 20 is attached to the first electrode plate and a second electrode tap 30 is attached to the second electrode. The electrode assembly 10 is electrically connected with the outside by the first and second electrode taps 20, 30 attached to the electrode plates. Hereinafter, the first electrode plate is referred to as an anode plate and the second electrode plate is referred to as a cathode plate, for the convenience of description.

The anode plate includes an anode active material layer and an uncoated part. The anode active material layer is a portion coated with an anode active material on both sides or one side of an anode collector and the uncoated part is a portion without the anode active material coated in the anode collector.

In general, the anode collector is a material having high conductivity and is not specifically limited as long as it does not cause chemical changes. For example, the anode collector may be made of aluminum, nickel, titanium, and calcination carbon. The anode active material layer includes an anode active material, which is a layered compound containing lithium, a conductive material improving conductivity, and a binder improving bonding force between the layered compound and the conductive material. The anode active material layer is formed by mixing the anode active material, the conductive material, and the binder with a solvent in a slurry and then applying the slurry to the anode collector. Preferably, the solvent may be NMP (N-Methyl-2-Pyrrolidone), the anode active material may be lithium cobalt oxide (LiCoO₂), the conductive material may be acetylene black, and the binder may be polyvinylidene fluoride, but they are not limited thereto.

The cathode plate includes a cathode active material layer and an uncoated part. The cathode active material layer is a portion coated with a cathode active material on both sides or one side of cathode collector and the uncoated part is a portion without the cathode active material coated in the cathode collector.

In general, the cathode collector is a conductive metal plate, and for example, may be made of copper, stainless steel, aluminum, and nickel. The cathode active material layer is formed by mixing the cathode active material and a binder improving bonding force of the cathode active material with a solvent in a slurry and then applying the slurry to the cathode collector. Preferably, the solvent may be NMP (N-Methyl-2-Pyrrolidone), the cathode active material may be graphite, and the binder may be polyvinylidene fluoride, but they are not limited thereto. As described above, when graphite is used for the cathode active material, the anode plate corresponding to the cathode plate may have a smaller area than the cathode plate. On the other hand, when tin oxide (SnO) or lithium titanium oxide (ITO) is used for the cathode active material, the anode plate corresponding to the cathode plate may have a larger area than the cathode plate.

The separator is interposed between the anode plate and the cathode plate. The separator functions as an ion path and prevents contact between the anode plate and the cathode plate. Therefore, the separator is formed of an insulating thin film having high ion transmittance and mechanical strength. For example, the separator may be porous film or non-woven fabric including polyethylene, polypropylene, or polyvinylidene fluoride.

The electrode assembly 10 is formed by winding the anode plate and the cathode plate with the separator interposed therebetween. The electrode assembly 10 wound as described above is accommodated with electrolyte in the pouch case 110 and the pouch case 110 is sealed, thereby forming the secondary battery 100.

Further, the electrode assembly 10 includes a first electrode tap 20 and a second electrode tap 30. The electrode taps 20, 30 are attached to the uncoated parts of the anode plate and the cathode plate, respectively. The first and second electrode taps 20, 30 may be made of nickel or aluminum. Further, the electrode taps 20, 30 are attached to the electrode plates by any one or more of ultrasonic welding, resistance welding, and laser welding. In the pouch-type secondary battery 100 of the present invention, the first and second electrode taps 20, 30 are exposed to the outside of the case 110 through the bonding portion 140 of the pouch-typed case 110. Therefore, the electrode assembly 10 is electrically connected with the outside by the first and second electrode taps 20, 30 attached to the electrode plates.

In the secondary battery 100 according to the present invention, the pouch-typed case 110 accommodating the electrode assembly 10 is composed of a cover 120 and a main body 130. The main body 130 of the pouch-typed case 110 has a housing portion 130a that is a space for accommodating the electrode assembly 10 and the bonding portion 140 extending outside from the inlet of the housing portion 130a. The housing portion 130a may be formed by deep-drawing an integral rectangular laminate sheet. The cover 120 is integrally connected with one side of the bonding portion 140. The secondary battery 100 is manufactured by disposing the electrode assembly 10 in the housing portion 130a of the main body 130 and then thermal-bonding the bonding portion 140, with the main body 130 and the cover 120 in close contact.

The laminate sheet of the pouch-typed case 110 includes an inner resin layer, a metal layer, and an outer resin layer. In general, the metal layer is a thin aluminum layer and the upper and lower sides of the thin aluminum layer are covered with synthetic resin, such as polypropylene or polyethylene. Accordingly, the laminate sheet has a stacked structure including the metal layer, the inner resin layer, and the outer resin layer. Further, the inner resin layer is made of a heat adhesive resin to seal the case 110. Therefore, the case is sealed by pressing the inner resin layer, particularly heating and pressing the bonding portion.

In general, an insulating tape should be attached to the electrode taps of the pouch-typed secondary battery. On the other hand, an insulating tape is not attached to the electrode taps 20, 30 in the electrode assembly 10 of the secondary battery according to the present invention.

The insulating tape is provided to prevent contact and short-circuit between the metal layer of the laminate sheet and the electrode taps 20, 30, when sealing the pouch-typed case 110. However, the insulating tape interferes with bonding of the bonding portion 140 and the cover 120 of the pouch-typed case 110. Therefore, bonding of the pouch-typed case 110 may be incompletely made by the insulating tape, such that a path through which moisture permeates from the outside or the electrolyte leaks from the inside to the outside may be formed. Hereafter, this is described in detail.

The pouch-typed case 110 is sealed by thermal bonding, after accommodating the electrode assembly 10 and the electrolyte therein. In detail, the bonding portion 140 of the pouch-typed case 110 and the cover 120 contacting the bonding portion 140 are pressed by a specific jig and heated above predetermined temperature. The electrode taps 20, 30 exposed to the outside through the bonding portion 140, however, interfere with controlling temperature and pressure required for the thermal bonding of the case 110. Further, non-uniform pressure is applied by the thickness of electrode taps 20, 30 and the insulating tapes attached to the electrode taps 20, 30. That is, higher temperature and pressure than the thermal bonding are applied to the portions where the electrode taps 20, 30 are positioned, in the bonding portion 140.

That is, temperature and pressure concentrate on the portions where the electrode taps 20, 30 are positioned. Therefore, the insulating tapes attached to the electrode taps 20, 30 are easily damaged. When the insulating tapes are damaged, a short-circuit may be caused by contact between the electrode taps 20, 30 and the metal layer of the pouch-typed case 110. In particular, the insulating tapes are more damaged, when the electrode taps 20, 30 are not made of the same kind of metal as the metal layer. As described above, there is a problem that it is difficult to ensure sufficient safety for the secondary battery 100, with the insulating tapes attached to the electrode taps 20, 30.

However, secondary batteries according to the present invention make it possible to improve sealability of the pouch-typed case 110 without a short-circuit between the electrode taps and the case, even without using an insulating tape.

Referring to FIGS. 1 and 3, an insulating tape is not attached to the first and second electrode taps 20, 30 of the secondary battery 100 according to the present embodiment. Further, the case 110 of the secondary battery 100 according to the present embodiment further includes an additional bonding member 150 in the housing portion 130a and the bonding portion 140. The bonding member 150 is only formed the bonding portion that is bonded.

As described above, the case 110 is composed of the inner resin layer 110a, the metal layer 110b, and the outer resin layer 110c. The inner resin layer 110a is a layer that is thermal-bonded by heat and pressure applied with the electrode assembly 10 accommodated, and usually made of CPP (cast polypropylene). Further, the inner resin layer 110a may further include an adhesive layer. The adhesive layer supplements small bonding force of the inner resin layer 110 to the metal layer 110b. The metal layer is a layer preventing air, moisture etc. from flowing into the battery and usually made of aluminum. The outer resin layer protects the battery from the outside, such that it needs high tensile strength and weatherability to the thickness. For example, stretched nylon film may be used for the outer resin layer.

The bonding member 150 is separately formed and disposed on the inner resin layer 110a, which is the upper surface of the bonding portion 140 of the case 110. That is, the independent bonding member 150 is disposed on the upper surface of the bonding portion 140. Accordingly, the bonding portion 140 that is bonded in the case 110 has a thickness different from the other portions. That is, since the independent bonding member 150 is disposed on the bonding portion 140, the bonding portion 140 of the case 110 increases in thickness as much as the thickness of the bonding member 150.

The bonding member 150 may be selectively made of any one or more of polypropylene, polyethylene, polyterephthalate, and polyacrylonitrile. Further, the thickness of the bonding member 150 may be 100 μm to 200 μm. The bonding member 150 is likely to be damaged in the bonding or thermal bonding, when the thickness of the bonding member 150 is smaller than 100 μm. Therefore, there may be a problem that current flows through the damaged portion of the bonding portion. Further, it may be difficult to seal the case 110, when the thickness of the bonding member 150 is larger than 200 μm.

Referring to FIG. 2, when the secondary battery 110 is manufactured with the pouch-typed case 110 including the bonding member 150, a short-circuit does not occur even without attaching an insulating tape to the first and second electrode taps 20, 30 of the electrode assembly 10. As shown in the figures, the first and second electrodes 20, 30 of the electrode assembly 10 are exposed to the outside through the bonding portion 140 of the case 110. The case 110 is bonded by pressing the bonding portion 140 at high temperature.

In the thermal bonding, the secondary battery 110 according to the present embodiment, a short-circuit with the case 110 does not occurred even though an insulating tape is not attached to the electrode taps 20, 30. Further, since the bonding portion 140 of the case 110 is uniformly bonded by the bonding member 150, sealability of the case 110 is improved. As described above, the bonding member 150 is manufactured separately from the pouch-typed case 110 and attached to the bonding portion 140.

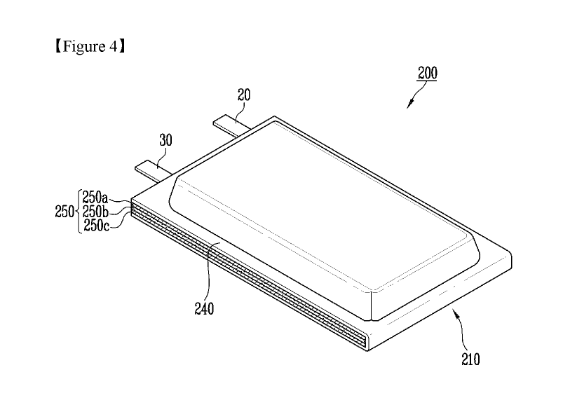

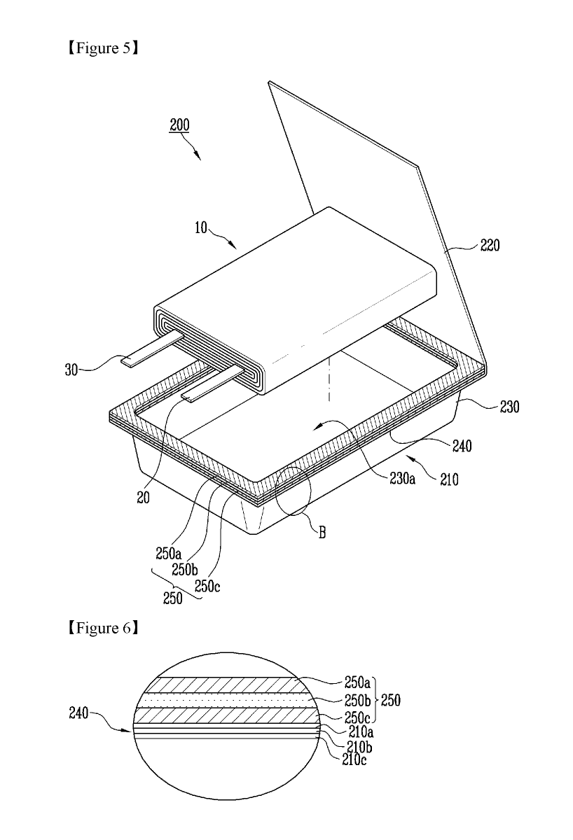

FIG. 4 is a perspective view of a pouch-type secondary battery according to an embodiment of the present invention, FIG. 5 is an exploded view of the secondary battery shown in FIG. 4, and FIG. 6 is a view enlarging the portion B of FIG. 5.

A pouch-typed secondary battery according to another embodiment of the present invention is described hereafter with reference to FIGS. 4 to 6.

Referring to FIGS. 4 and 5, a pouch-type secondary battery 200 according to the present embodiment includes an electrode assembly 10, a pouch-typed case 210 accommodating the electrode assembly 10, and bonding members 250 composed of a plurality of layers to seal the pouch-typed case 210. The case 210 has a bonding portion 240 where the bonding members 250 are disposed.

The electrode assembly 10 is formed by winding an anode plate, a cathode plate, and a separator interposed between the electrode plates. A first electrode tap 20 is attached to the anode plate and a second electrode plate 30 is attached to the cathode plate. The electrode assembly 10 is electrically connected with the outside by the first and second electrode taps 20, 30 attached to the electrode plates. As described above, an insulating tape is not attached to the electrode taps 20, 30. Other than the above, the configuration and operation of the electrode assembly 10 of the secondary battery 200 according to the present embodiment are the same as those of the electrode assembly 10 shown in FIGS. 1 to 3, and the detailed description is not provided.

In the secondary battery 200 according to the present embodiment, the pouch-typed case 210 accommodating the electrode assembly 10 is composed of a cover 220 and a main body 230. The main body 230 of the pouch-typed case 210 has a housing portion 230a that is a space for accommodating the electrode assembly 10 and the bonding portion 240 extending outside from the inlet of the housing portion 230a. The housing portion 230a may be formed by deep-drawing an integral rectangular laminate sheet. The cover 220 is integrally connected with one side of the bonding portion 240. The secondary battery 200 according to the present embodiment is manufactured by disposing the electrode assembly in the housing portion 230a of the main body 230 and then thermal-bonding the bonding portion 240 where the bonding members 250 are disposed, with the main body 230 and the cover 120 in close contact.

As described above, the case 210 is composed of the outer resin layer 210a, the metal layer 210b, and the inner resin layer 210c. The inner resin layer 210a is usually made of CPP, but may further include an adhesive layer to supplement bonding force. The metal layer 210b is generally made of aluminum and the outer resin layer 210c may be made of stretched nylon film. Other than the above, the configuration of the case 210 is the same as that the case 110 shown in FIGS. 1 to 3, and the detailed description is not provided.

Referring to FIGS. 5 and 6, the case 210 of the secondary battery 200 according to the present embodiment includes the bonding member 250 composed of a plurality of layers, which is separately manufactured. The bonding members 250 are disposed on the upper surface of the bonding portion 240 of the case 210. Further, the bonding members 250 are separately manufactured and disposed on the bonding portion 240, as shown in FIG. 5. Accordingly, the bonding portion 240 of the case 210 increases in thickness as much as the thickness of the bonding members 250 and the thickness is different from the other portions without the bonding members 250.

FIG. 6 is a view enlarging the bonding portion 240 and the bonding members 250 disposed on the upper surface of the bonding portion 240. The bonding member 250 is composed of a plurality of layers in the present embodiment. The bonding members 250 may be divided into first, second, and third bonding members 250a, 250b, 250c. As shown in FIG. 6, the second boding member 250b is disposed between the first and third bonding members 250a, 250c. Further, the second bonding member 250b may be made of the same material as the inner resin layer 210a of the case 210, but is not limited thereto. The second bonding member 250b may be made of various polymers, in accordance with the design of the secondary battery. Preferably, the second bonding member 250b may be made of CPP.

The first bonding member 250a is a portion that contacts the first and second electrode taps 20, 30. The first and second electrode taps 20, 30 are exposed to the outside through the first bonding member 250a. Further, the bonding portion 240 is sealed substantially by the first bonding member 250a, when the cover 220 and the main body 230 of the case 210 is thermal-bonded. The first bonding member 250a may be selectively made of any one or more of polypropylene, polyethylene, polyterephthalate, and polyacrylonitrile. Further, the thickness of the first bonding member 250a may be 100 μm to 200 μm. The first bonding member 250a is likely to be damaged in the bonding or thermal bonding, when the thickness of the first bonding member 250a is smaller than 100 μm. Further, it may be difficult to seal the case 210, when the thickness of the first bonding member 250a is larger than 200 μm.

The third bonding portion 250c is a portion that directly contacts the bonding portion 240 of the case 210. The third bonding member 250c may be made of the same material as the second bonding member 250b described above. Further, the third bonding member 250c may be made of the same material as the first bonding member 250a. The interface between the second bonding member 250b and the third bonding member 250c is removed, when the third bonding member 250c and the second bonding member 250b are made of the same material. Therefore, the bonding members 250 becomes composed of only two layers. Further, when the third bonding member 250c and the first bonding member 250a are made of the same material, it does not need to discriminate the portion contacting the cover 220 of the case or the portion contacting the main body 230 in the bonding members 250. That is, the upper surface and the lower surface of the bonding members 250 is not discriminated. Therefore, it does not need to distinguish the direction of the bonding member 250 and the process efficiency is increased, when the bonding members 250 are separately manufactured and attached to the case 210.

The bonding members 250 of the secondary battery 210 according to the present embodiment are shown to be composed of three layers, but as described above, the layers of the bonding member 250 may be less than three. Further, the layers of the bonding members 250 may be more than three. This depends on the kinds of materials of the layers of the bonding members 250.

As described above, the bonding members 250 composed of a plurality of layers are disposed in the bonding portion 240 of the pouch-typed case 210 according to the present embodiment. Therefore, the thickness of the bonding member 250 is added to the bonding portion 240 and the depth of the housing portion 230a of the main body 230 correspondingly increases.

The housing portion 230a of the main body 230 is a space accommodating the electrode assembly 10. The depth of the housing portion 230a depends on the thickness of the electrode assembly 10. The housing portion 230a may be formed by deep drawing. The deep drawing is a method of manufacturing a container without a joint from a flat plate. A circular cylinder, a polygonal cylinder, and other complicated shapes can be achieved by the method. The resin layer of the laminate has small durability than the metal layer. Therefore, the depth of the housing portion 230a which can be achieved by deep drawing is limited by the resin layer.

On the other hand, in the case 210 including the bonding members 250 according to the present embodiment, the depth of the housing portion 230a is increased by the bonding members 250 composed of a plurality of layers. That is, the thickness of the bonding portion 240 with the bonding members 250 is relatively increased as much as the thickness of the bonding members 250, by the thickness of the bonding members 250 themselves, which are composed of a plurality of layers. Accordingly, the housing portion 230a can generally accommodate the electrode assembly 10 having a thickness as much as the depth, which can be achieved by deep drawing, added with the thickness of the bonding members 250.

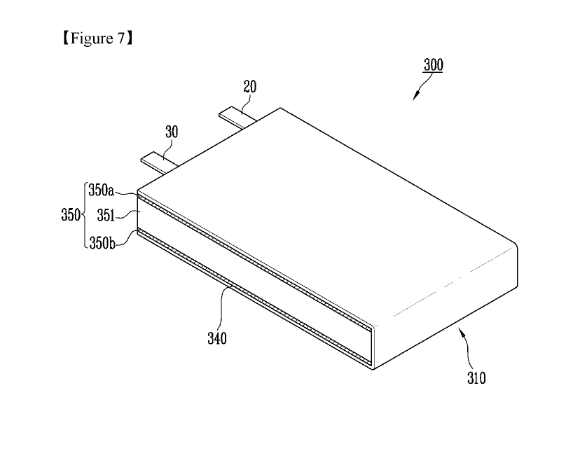

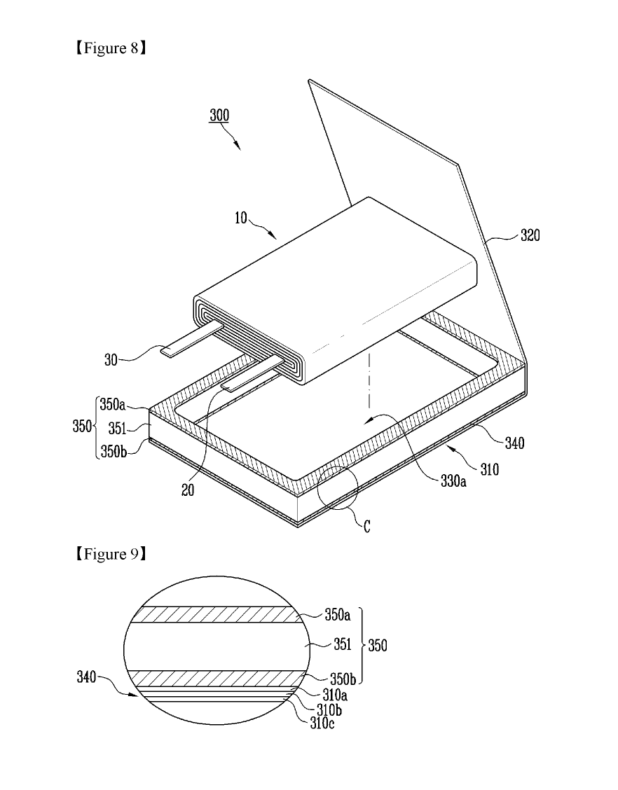

FIG. 7 is a perspective view of a pouch-type secondary battery according to an embodiment of the present invention, FIG. 8 is an exploded view of the secondary battery shown in FIG. 7, and FIG. 9 is a view enlarging the portion C of FIG. 8.

A pouch-typed secondary battery according to another embodiment of the present invention is described hereafter with reference to FIGS. 7 to 9.

Referring to FIGS. 7 and 8, a pouch-type secondary battery 300 according to the present embodiment includes an electrode assembly 10, a pouch-typed case 310 accommodating the electrode assembly 10, and bonding members 350 composed of a plurality of layers to seal the pouch-typed case 310. The case 310 has a bonding portion 340 where the bonding member 350 for sealing the case 310 is disposed.

Seeing the electrode assembly 10, the electrode assembly 10 is formed by winding an anode plate, a cathode plate, and a separator interposed between the electrode plates. A first electrode tap 20 is attached to the anode plate and a second electrode plate 30 is attached to the cathode plate. As described above, an insulating tape is not attached to the electrode taps 20, 30. The electrode assembly 10 of the secondary battery 300 according to the present embodiment is the same as the electrode assembly 10 shown in FIGS. 1 to 3, and the detailed description is not provided.

In the secondary battery 300 according to the present embodiment, the cover 320 is integrally connected with one side of the main body at a predetermined distance in the pouch-typed case 310 accommodating the electrode assembly 10, in the secondary battery 300 according to the present embodiment. Practically, the case 310 according to the present embodiment does not undergo deep drawing. Therefore, the case 310 itself is not divided into a main body and a cover. That is, there is no space accommodating the electrode assembly 10 in the case 310. In the present embodiment, when the case 310 of the secondary assembly 300 is not provided with the bonding members 350, the cover 320 and the main body of the case 310 are not separated and the same. Therefore, the bonding members 350 can be disposed anywhere, the upper surface of the lower surface, of the case 310, because it does not need to distinguish the cover 320 and the main body in the case 310. Hereinafter, for the convenience of description, assume that the main body is the surface where the bonding members 350 are provided and the housing portion 330a of the electrode assembly 10 is formed, and the cover 320 is the surface corresponding to the main body. In the figures, the bonding members 350 are separately manufactured and provided in the case 310.

As described above, the case 310 is composed of the outer resin layer 310a, the metal layer 210b, and the inner resin layer 210c. The inner resin layer 310a is usually made of CPP and may further include an adhesive layer to supplement bonding force. The metal layer 310b is generally made of aluminum and the outer resin layer 310c may be made of stretched nylon film.

As described above, the case 310 itself according to the present embodiment does not have a space for accommodating the electrode assembly 10. On the other hand, the housing portion 330a accommodating the electrode assembly 10 may be formed by the bonding members 350. In detail, the bonding members 350 having a predetermined thickness is disposed on the upper surface of the bonding portion 340 of the case 310. Therefore, the case 310 has the housing portion 330a that can accommodate the electrode assembly 10, by the thickness of the bonding members 350. The thickness of the housing portion 330a formed as described above may depend on the thickness of the bonding members 350 disposed on the bonding portion 340.

In the present embodiment, the case 310 does not undergo deep drawing, unlike the embodiments described above. Accordingly, since deep drawing is not performed, it is possible to reduce the manufacturing cost of the secondary battery 300. Further, the depth of the housing portion 330a which can be achieved by deep drawing was limited. However, since the housing portion 330a of the case 310 is not formed by deep drawing in the secondary battery 300 according to the present embodiment, the depth of the housing 330a is not limited. That is, it does not limited by the thickness of the electrode assembly 10 accommodated in the case 310 and it is possible to accommodate the electrode assembly 10 having various thicknesses. Therefore, it has the advantage of manufacturing a secondary battery having thickness electrode assembly 10, that is, high capacity. Other than the above, the configuration of the case 310 is the same as that the case 310 shown in FIGS. 1 to 3, and the detailed description is not provided.

As described above, in the case 310 of the secondary battery 300 according to the present embodiment, the space accommodating the electrode assembly 10 inside the case 310 is formed by the bonding members 350. Hereinafter, the bonding members 350 used in the present embodiment is described in detail.

Referring to FIGS. 8 and 9, there is included in the case 310 of the secondary battery 300 according to the present embodiment and the bonding members 350 having a spacer for sealing the case 310. The bonding members 350 are disposed on the upper surface of the bonding portion 340 of the case 310. Further, the bonding members 350 are separately manufactured and disposed on the bonding portion 340.

FIG. 9 is a view enlarging the bonding portion 340 and the bonding members 350 disposed on the upper surface of the bonding portion 340. The bonding member 350 includes the spacer 351 in the present embodiment. That is, the bonding members 350 are composed of first and second bonding members 350a, 350b, and the space 351 disposed between the first and second bonding members 350a, 350b.

The first bonding member 350a is a portion that contacts the first and second electrode taps 20, 30. The first and second electrode taps 20, 30 are exposed to the outside through the first bonding member 350a. Further, the first bonding member 350a is a portion that is substantially thermal-bonded with the cover 320 of the case 310.

The first bonding member 350a may be selectively made of any one or more of polypropylene, polyethylene, polyterephthalate, and polyacrylonitrile. Further, it is preferable that the thickness of the first bonding member 350a may be 100 μm to 200 μm. The first bonding member 350a is likely to be damaged in the bonding or thermal bonding, when the thickness of the first bonding member 350a is smaller than 100 μm. Further, the electrolyte may leak due to incomplete sealing of the case 310, when the thickness of the first bonding member 350a is larger than 200 μm.

Further, the second bonding member 350 is a portion contacting the inner resin layer 310a of the case 310. The interface between the second bonding member 350b and the inner resin layer is unclear, when the second bonding member 350b is made of the same material as the inner resin layer 310a of the case 310. Further, the second bonding member 350b may be made of the same material as the first bonding member 350a described above. In this case, it is advantageous to attach the bonding members 350 separately manufactured to the case 310. That is, since it does not need to distinguish the upper surface from the lower surface of the bonding members 350, it is possible to reduce errors caused in the related process.

Further, it is possible to simplify the process, when attaching the bonding members 350 to the case 310. That is, it is possible to dispose the bonding members 350 between the cover 320 and the main body of the case and then attach at one time the cover 320, the bonding members 350, and the main body, without separately attaching the bonding members 350 to the case 310 and then attaching the cover 320 to the bonding member 350. Further, it is possible to reduce the manufacturing cost, because there is no need to add a process of attaching the bonding members 350 to the case 310. The material of the second bonding member 350b described above is and example and may be various polymers.

Referring to FIGS. 8 and 9, the upper surface of the spacer 351 is covered with the first bonding member 350a and the lower surface is covered with the second bonding member 350b. The bonding members 350 include the first and second bonding members 350a, 350b, and the spacer disposed therebetween. The bonding members 350, particularly, the cover 320 is spaced apart from the main body by the spacer 351, and accordingly, the housing portion 330a accommodating the electrode assembly 10 is formed inside the case 310.

Further, the spacer 351 spaces the cover 320 and the main body of the case 310 and should not react with the electrolyte such that the electrode assembly 10 is not influenced by external pressure. Therefore, the spacer 351 should have high mechanical strength and anticorrosion. In general, the spacer 351 may be formed by molding metal having high strength and good forming performance, or engineering plastic. In this configuration, the metal may be aluminum, stainless steel, and nickel, and the plastic may be Polycarbonate, nylon, polyimide, polybutylene terephthalate, and polyethylene terephthalate. As described above, the spacer 351 can be made of a material that maintains a constant space in the case 310 and does not react with the electrolyte therein, such that the material is not limited.

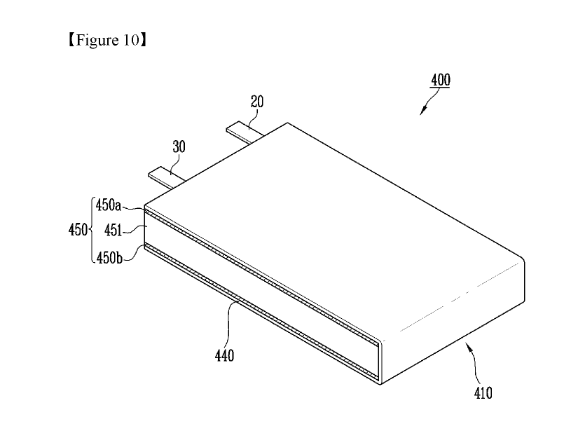

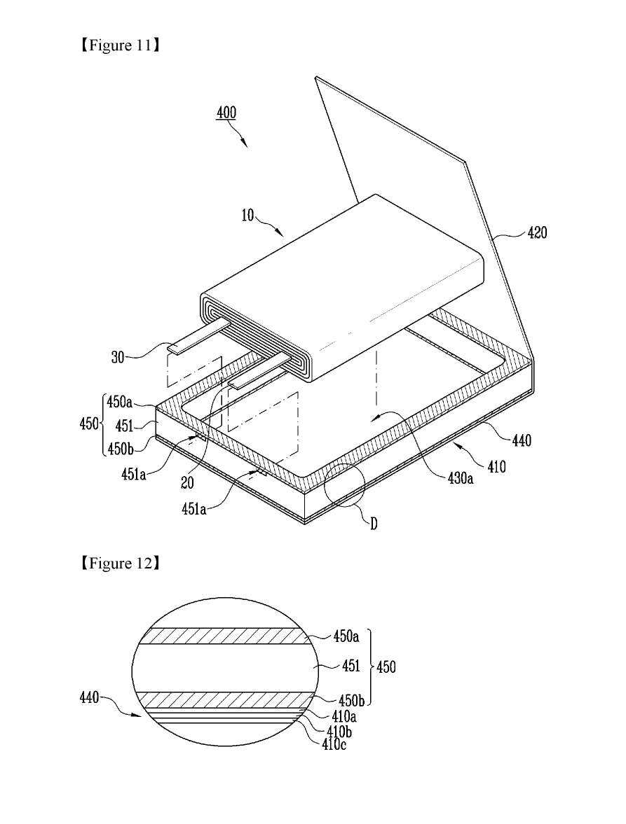

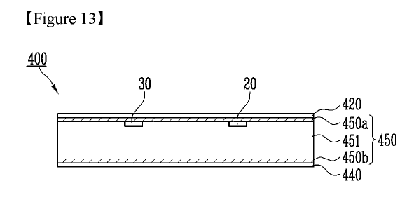

FIG. 10 is a perspective view of a pouch-typed secondary battery according to the present embodiment, FIG. 11 is an exploded view of the secondary battery shown in FIG. 10, FIG. 12 is a view enlarging the portion D of FIG. 11, and FIG. 13 is a view showing the front of the pouch-typed secondary battery according to the present embodiment.

A pouch-typed secondary battery according to another embodiment of the present invention is described hereafter with reference to FIGS. 10 to 12.

Referring to FIGS. 10 and 11, a pouch-type secondary battery 400 according to the present embodiment includes an electrode assembly 10, a pouch-typed case 410 accommodating the electrode assembly 10, and bonding members 450 composed of a plurality of layers to seal the pouch-typed case 410. The case 410 has a bonding portion 440 and bonding members 450 separately manufactured are disposed on the bonding portion 440.

The electrode assembly 10 is formed by winding an anode plate, a cathode plate, and a separator interposed between the electrode plates. A first electrode tap 20 is attached to the anode plate and a second electrode plate 30 is attached to the cathode plate. As described above, an insulating tape is not attached to the electrode taps 20, 30. The electrode assembly 10 of the secondary battery 400 according to the present embodiment is the same as the electrode assembly 10 shown in FIGS. 1 to 3, and the detailed description is not provided.

In the secondary battery 400 according to the present embodiment, the pouch-typed case 410 accommodating the electrode assembly 10 is composed of a cover 420 and a main body 420 integrally connected with one side of the cover 420. The case 410 according to the present embodiment does not undergo deep drawing. Therefore, the case 410 itself is not provided with a space accommodating the electrode assembly. That is, when the case 410 of the secondary battery does not the bonding members 450, the housing portion 430a is not formed in the case 410, such that the case 410 is not substantially divided into the cover 420 and the main body. That is, the bonding members 450 may be disposed anywhere, on the upper surface or the lower surface of the case 410, and the housing portion 430a is formed in the surface where the bonding members 450 are disposed. Hereinafter, assume that the main body is the surface where the housing portion 430a is formed by the bonding members 450 and the cover 420 is the surface corresponding to the main body.

The secondary battery 400 according to the present embodiment is manufactured by disposing the electrode assembly 10 in the housing portion 430a and then thermal-bonding the bonding members 450 are disposed, with the main body 430 and the cover 420 in close contact.

As described above, the case 410 is composed of the outer resin layer 410a, the metal layer 410b, and the inner resin layer 410c. The inner resin layer 410a is usually made of CPP and may further include an adhesive layer to supplement bonding force. The metal layer 410b is generally made of aluminum and the outer resin layer 410c may be made of stretched nylon film. Further, the case 410 of the secondary battery 400 according to the present embodiment does not need deep drawing. Therefore, it is possible to reduce the manufacturing cost and the thickness that can be achieved by deep drawing is not limited. It is not limited to the thickness of the electrode assembly 10. Other than the above, the configuration of the case 410 is the same as that the case 110 shown in FIGS. 1 to 3 and the case 310 shown in FIGS. 7 to 9, and the detailed description is not provided.

Hereinafter, the bonding members 450 disposed in the secondary battery according to the present embodiment is described in detail with reference to FIGS. 11 and 12.

As described above, in the case 410 of the secondary battery 400 according to the present embodiment, the space accommodating the electrode assembly 10 inside the case 410 is formed by the bonding members 450 disposed on the upper surface of the bonding portion 440. The case 410 includes the bonding members 450 with the spacer 451. The bonding members 450 are disposed on the upper surface of the bonding portion 440 of the case 410. Further, the bonding members may be integrally formed as shown in FIG. 8, but may be separated manufactured and attached.

Referring to FIG. 12, the bonding members 450 include the first and second bonding members 450a, 450b, and the space 450 disposed between the first and second bonding members 450a, 450b. The second bonding member 450b may be made of the same material as the inner resin layer 410a of the case 410, but is not limited thereto. The second bonding member 450b may be made of various polymers, in accordance with the design of the secondary battery. Preferably, the second bonding member 450b may be made of CPP.

The first bonding member 450a is a portion that contacts the first and second electrode taps 20, 30, and is substantially thermal-bonded with the cover 420 of the case 410. The first bonding member 450a may be selectively made of any one or more of polypropylene, polyethylene, polyterephthalate, and polyacrylonitrile. Further, it is preferable that the thickness of the first bonding member 450a may be 100 μm to 200 μm. The first bonding member 450a is likely to be damaged in the bonding or thermal bonding, when the thickness of the first bonding member 450a is smaller than 100 μm. Further, the electrolyte may leak due to incomplete sealing of the case 410, when the thickness of the first bonding member 450a is larger than 200 μm.

Further, the second bonding member 450 is a portion contacting the inner resin layer 410a of the case 410. The second bonding member 450b is absorbed in the inner resin layer and not distinguished, when the second bonding member 450b is made of the same material as the inner resin layer 410a of the case 410. As a result, the bonding members 450 are composed of only the first bonding member 450a and the spacer 451. Further, the second bonding member 450b may be made of the same material as the first bonding member 450a described above. In this case, it has the advantage of simultaneously attaching the bonding members 450 in thermal-bonding the case 410, when separately manufacturing the bonding members 450a and attaching to the case 410. Further, it is possible to reduce the manufacturing cost, because there is no need to add a process of attaching the bonding members 450 to the case 410. The material of the second bonding member 450b described above is and example and may be various polymers.

Referring to FIGS. 11 and 12, thee upper surface of the spacer 451 is covered with the first bonding member 450a and the lower surface is covered with the second bonding member 450b, and the bonding members 450 are composed of the first and second bonding members 450a, 450b and the spacer 451. The housing portion 430a is formed in the case 410 by the spacer 451. The spacer 451 maintains the gap between the cover 420 and the main body of the case 410. Further, the spacer 451 may be formed by molding metal having high strength and good forming performance, or engineering plastic such that the electrode assembly is not influenced by external pressure. In this configuration, the metal may be aluminum, stainless steel, and nickel, and the plastic may be Polycarbonate, nylon, polyimide, polybutylene terephthalate, and polyethylene terephthalate. The spacer 451 can be made of a material that maintains a constant space in the case 410 and does not react with the electrolyte therein, such that the material is not limited.

Referring to FIGS. 11 to 13, the spacer has two steps 451a. The two steps 451 are spaced apart from each other and formed on the upper surface of the spacer 451. Accordingly, the steps 451a contact the first bonding member 450a. The steps 451 are paths through which the first and second electrode taps 20, 30 of the electrode assembly 10 pass. Therefore, since the first and second electrode taps 20, 30 are not interfered by the space formed by the steps 451a, when the case 410 of the secondary battery according to the present embodiment, it is possible to bond well the bonding portion 440. Since the steps 451a can be formed in the process of manufacturing the spacer 451, an additional process is not needed. Further, since the first and second electrode taps 20, 30 are spaced by the steps 451a, thereby preventing a short-circuit. Other than the above, the configuration and operation of the spacer 451 are the same as the spacer 351 shown in FIGS. 7 to 9, the detailed description is not provided.

Although the spirit of the present invention was described in detail in accordance with the exemplary embodiment, it should be understood that the embodiments are provide to explain the present invention and do not limit the present invention. It should be understood that the present invention may be changed and modified in various ways by those skilled in the art, without departing from the scope of the present invention.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and-equivalents thereof.

### DESCRIPTION OF REFERENCE NUMERALS IN THE DRAWINGS

10: electrode assembly

20: first electrode tap

30: second electrode tap

100, 200, 300, 400: secondary battery

110, 210, 310, 410: pouch-typed case

140, 240, 340, 440: bonding portion

150, 250, 350, 450: bonding member

200: secondary battery

210: pouch-typed case

240: bonding portion

250: bonding member

300: secondary battery

310: pouch-typed case

340: bonding portion

350: bonding member

351: spacer

400: secondary battery

410: pouch-typed case

440: bonding portion

450: bonding member

451: spacer

What is claimed is:

1. A pouch-type secondary battery comprising:
a case that defines a first space at least partially enclosed by a perimeter wherein the case includes a cover and wherein the case defines a first surface;
an electrode assembly that is positioned within the first space wherein the electrode assembly includes at least one electrode tab that extends outward from the electrode assembly;
at least one bonding member that is positioned on the first surface of the case so as to define an interface portion that interfaces with a portion of the cover to thereby bond the cover to the first surface of the case.

2. The battery of claim 1, wherein the thickness of the interface portion is thicker than the thickness of the cover or the first surface.

3. The battery of claim 1, wherein the at least one tab extends outward from the first space of the case with at least a portion of the bonding member interposed between the tab and the first surface.

4. The battery of claim 1, wherein the case is formed of a laminate having an inner resin layer, an outer resin layer and a metal layer interposed therebetween.

5. The battery of claim 4, wherein the inner resin layer includes an adhesive layer.

6. The battery of claim 5, wherein the inner resin layer is formed of cast polypropylene, the metal layer comprises a layer of aluminum and the outer resin layer comprises stretched nylon film.

7. The battery of claim 1, wherein the at least one bonding member includes at least one of polypropylene, polyethylene, polyethylene terephthalate; or polyacrylonitrile.

8. The battery of claim 7, wherein the at least one bonding member is approximately 100 μm to 200 μm thick.

9. The battery of claim 1, wherein the at least one bonding member is formed of a plurality of layers.

10. The battery of claim 9, wherein the at least one bonding member comprises a first layer, a second layer and a third layer, wherein the first layer contacts the cover and wherein the third layer contacts the first surface of the case.

11. The battery of claim 10, wherein the first, second and third layers are formed of the same material.

12. The battery of claim 9, wherein the plurality of layers of the bonding member include a first and a second layer with a spacer interposed therebetween.

13. The battery of claim 10, wherein the first and second layers include at least one of polypropylene, polyethylene, polyethylene terephthalate; and
polyacrylonitrile.

14. The battery of claim 12, wherein the spacer is formed of a metal or a plastic.

15. The battery of claim 14, wherein the spacer includes at least one of aluminum, stainless steel, nickel, polycarbonate, nylon, polyamide, polybutylene terephthalate or polyethylene terephthalate.

16. The battery of claim 12, wherein at least one step is formed in the spacer and wherein the at least one electrode tab extends outward from the first space of the case via the at least one step.

17. The battery of claim 1, wherein the first surface of the case comprises a flange that extends around the first space and wherein the first space defines a recess that at least partially receives the electrode assembly.

18. The battery of claim 17, wherein the at least one bonding member is positioned on the flange so as to be interposed between the cover and the flange.

19. The battery of claim 1, wherein the first surface of the case comprises at least a portion of a planar surface and wherein the first space that receives the electrode assembly is defined by the planar surface and the at least one bonding member so that the at least one bonding member defines the depth of the first space.

20. A pouch-type secondary battery comprising:
a case that defines a first space at least partially enclosed by a perimeter wherein the case includes a cover and wherein the case defines a first surface and wherein the case has a first thickness;
an electrode assembly that is positioned within the first space wherein the electrode assembly includes at least one electrode tab that extends outward from the electrode assembly;
at least one bonding member that is positioned on the first surface of the case so as to define an interface portion that interfaces of a first thickness substantially about the perimeter of the first space wherein the at least one tab extends outward from the first space of the case with at least a portion of the bonding member interposed between the tab and the first surface wherein the at least a portion of the bonding member sufficiently insulates the at least one tab from the case so that the at least one tab directly contacts the at least one bonding member.
